(19) United States
(12) Patent Application Publication
(10) Pub. No.: US 2026/0347514 A1
(43) Pub. Date: Nov. 5, 2026

(54) CATALYTIC MODULATION OF NETWORK TOPOLOGY IN CROSSLINKED PHOTOPOLYMERS

(71) Applicant: University of Denver, Denver, CO (US)

(72) Inventors: Brady Worrell, Denver, CO (US); Nicholas Bagnall, Littleton, CO (US); Meredith Jones, Denver, CO (US)

(73) Assignee: University of Denver, Denver, CO (US)

(21) Appl. No.: 19/123,673

(22) PCT Filed: Oct. 31, 2023
(86) PCT No.: PCT/US23/36516

§ 371 Date: Apr. 23, 2025

Related U.S. Application Data
(60) Provisional application No. 63/421,040, filed on Oct. 31, 2022.

(51) Int. Cl. C08F 4/80; C08F 2/38; C08F 2/50; C08F 120/14

(52) U.S. Cl. CPC C08F 4/80; C08F 2/38; C08F 2/50; C08F 120/14

(57) ABSTRACT

A method for producing photopolymers includes providing an active monomer feedstock, adding a catalytic chain transfer agent (CTA) to form a mixture with less than 30% concentration of the catalytic CTA, and applying energy from a light source to form a photopolymer structure, wherein the catalytic CTA is a Cobalt(II)-based catalyst. In embodiments, the concentration of the catalytic CTA is on the order of ten parts per million (ppm) of the mixture or less. In embodiments, the catalytic CTA exhibits a chain transfer constant 10 times higher or more than that of a sulfur-based catalytic CTA. In embodiments, the method includes adding a sigma-donating ligand (e.g., nitrogen-containing heterocycles, oxygen-containing heterocycles, sulfur-containing heterocycles, organophosphorus containing molecules, halide salts, nitrogen containing molecules, or oxygen containing molecules) to the catalytic CTA such that material properties (e.g., mechanical properties, optical properties, crosslinking density, and shelf stability) of the photopolymer structure therewith are modified.

### REFERENCE TO RELATED APPLICATIONS

The present application claims the benefit of U.S. Prov. Pat. App. No. 63/421,040, filed 2022 Oct. 31 and titled “Catalytic Modulation of Network Topology in Crosslinked Photopolymers,” which application is incorporated hereby in its entirety by reference.

### FIELD OF THE INVENTION

The present invention relates to catalysts and methods used to form photopolymers using catalytic chain transfer mechanisms. Aspects of the present disclosure also relate to the development of high-throughput methods for synthesizing, screening, and characterizing photopolymers.

### DESCRIPTION OF RELATED ART

Free-radical polymerization is used to convert methyl methacrylate (MMA) into high molecular weight poly(methyl methacrylate) (PMMA) with a high degree of polymerization (DP). PMMA polymers can then be processed to form a wide variety of commercial products. Due to the chain growth mechanism and rapid kinetics, it is difficult to form low molecular weight PMMA polymers, even if the polymerization is halted before completion.

In contrast to the thermally activated free-radical polymerization mechanisms discussed above, photopolymerization is a technique where light acts as a contactless stimulus, creating free radicals in great abundance. These free radicals convert mixtures of multifunctional methacrylate monomers into crosslinked thermosetting polymers. These photopolymers are highly crosslinked and tend to be brittle, exhibit high shrinkage, and have a limited range of material properties. CTAs have been employed to attempt to modulate the DP of the kinetic chain and improve the material properties. Non-catalytic sulfur-based CTAs have been successfully employed to modulate the crosslinking density (XLD) of these photopolymers. Examples of sulfur-based CTAs include mono-and multi-functional thiols, trithiocarbonates, dithiocarbonates, allyl sulfides, beta-allyl sulfones, vinyl sulfonate esters among others. The sulfur-based CTAs are required to be used in high loading (10 wt %-30 wt %), are malodorous, impart unwanted color to the polymer, and often create unstable formulations.

Accordingly, it would be advantageous to develop CTAs that can be used in the formation of photopolymers that allow broad control of the crosslinking and material properties of the photopolymer, can be used in small amounts, are not malodorous, do not impart unwanted color to the polymer, and create stable formulations.

Further, determining the optimal formulation to produce a desired crosslinked photopolymer is a painstaking and slow process that requires large quantities of materials, multiple pieces of analysis equipment, and large amounts of manpower. There are many variables that must be evaluated. Examples include light wavelength, intensity and duration (dose), photoinitiator identity and concentration, monomer(s) identity and concentration, temperature, CTA identity and concentration, presence of additives identity and concentration, among others. For each trial in the screening plan, enough polymer must be produced to allow the analysis of a suite of material properties. Examples of relevant material properties include crosslink density, toughness, solvent resistance, glass transition temperature, storage modulus (G′) loss modulus (G″), normal force (FN), shrinkage stress, among others. Several of these properties need to be determined as a function of temperature.

Accordingly, it would be advantageous to develop systems and methods that would allow high throughput screening of interesting polymers and reduce the time, amount of material, and manpower to investigate a wide range of the polymerization parameter space.

### SUMMARY OF THE INVENTION

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its purpose is to present some concepts of one or more aspects in a simplified form as a prelude to the more detailed description.

In embodiments, a method for producing photopolymers includes providing an active monomer feedstock, adding a catalytic chain transfer agent (CTA) to form a mixture with less than 30% concentration of the catalytic CTA, and applying energy from a light source to form a photopolymer structure, wherein the catalytic CTA is a Cobalt(II)-based catalyst. In certain embodiments, the concentration of the catalytic CTA is on the order of ten parts per million (ppm) of the mixture or less. In embodiments, the concentration of the catalytic CTA is on the order of ten parts per billion (ppb) of the mixture.

In embodiments, the catalytic CTA is sulfur-free, and the catalytic CTA exhibits a chain transfer constant 10 times higher or more than that of a sulfur-based catalytic CTA.

In embodiments, the method includes adding a sigma-donating ligand (e.g., nitrogen-containing heterocycles, oxygen-containing heterocycles, sulfur-containing heterocycles, organophosphorus containing molecules, halide salts, nitrogen containing molecules, or oxygen containing molecules) to the catalytic CTA such that material properties (e.g., mechanical properties, optical properties, crosslinking density, and shelf stability) of the photopolymer structure therewith are modified.

In embodiments, the active monomer feedstock includes a methacrylate monomer, a petroleum-derived (meth)acrylate, and/or a poly(methyl methacrylate) (PMMA). In embodiments, a molecular weight of the PMMA in the photopolymer structure is reduced from an order of thousands of Dalton (Da) in an unmodified photopolymer structure without the catalytic CTA to an order of hundreds of Da in the photopolymer including the catalytic CTA.

In embodiments, the catalytic CTA includes a Co(II)-complex. In embodiments, the catalytic CTA includes a Co(III)-hydride (Co(III)-H).

In embodiments, two or more wavelengths of light may be applied to the mixture to form the photopolymer.

In some embodiments, Co-based complexes are applied to the formation of photopolymers. The Co-based complexes are catalytic and can be used in small quantities (ppb to ppm levels) to modulate the network topology of the growing photopolymer. The molecular structure and concentration of the Co-based complexes can be varied to affect the material properties of the resulting photopolymer such as molecular weight, crosslink density, toughness, solvent resistance, thermal stability, glass transition temperature, storage modulus (G′) loss modulus (G″), normal force (FN), shrinkage stress among others. In some embodiments, the catalytically active species may be generated in-situ to provide temporal and spatial control of the photopolymer properties or to modulate gelation kinetics.

In embodiments, methods of using Co(II)-based catalysts in the synthesis of photopolymers are provided. The material properties of the resulting photopolymer may be changed by altering the R groups attached to the Co-based catalyst, the ligands attached to the Co-based catalyst, the concentration of the Co-based catalyst during the photopolymerization, and the oxidation state of the Co-based catalyst (e.g., reduction of Co(III) to Co(II) in situ). Methods for the high throughput screening, synthesis, and analysis of photopolymers formed using Co-based catalysts are provided.

Additionally, systems and methods are provided that allow for the improved high throughput screening of interesting polymers. The systems and methods allow for a reduction in the time, amount of material, and manpower required to investigate a wide range of the polymerization parameter space.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF DRAWINGS

The appended drawings illustrate only some implementations and are therefore not to be considered limiting of scope.

FIGS. 1A and 1B illustrate examples of the formation of polymers under different processing conditions, in certain embodiments.

FIG. 2 illustrates the synthesis of the family of Co-based catalysts, in certain embodiments.

FIGS. 3A and 3B illustrate examples of the formation and analysis of polymers under different processing conditions, in certain embodiments.

FIG. 4 presents analytical data of representative photopolymers.

FIG. 5 presents analytical data of representative photopolymers.

FIG. 6 presents analytical data of representative photopolymers.

FIG. 7 presents analytical data of representative photopolymers.

FIG. 8 presents alternative R groups and ligands used in the Co-based catalysts, in certain embodiments.

FIG. 9 illustrates a scheme for the high throughput synthesis and analysis of photopolymers formed using Co-based catalysts, in certain embodiments.

FIG. 10 illustrates a process whereby inactive Co(III) complexes can be activated using light to generate active Co(II)-based catalysts in-situ, in certain embodiments.

For simplicity and clarity of illustration, the drawing figures illustrate the general manner of construction, and descriptions and details of well-known features and techniques may be omitted to avoid unnecessarily obscuring the embodiments detailed herein. Additionally, elements in the drawing figures are not necessarily drawn to scale. For example, the dimensions of some of the elements in the figures may be exaggerated relative to other elements to help improve understanding of the described embodiments. The same reference numerals in different figures denote the same elements.

The word “exemplary” is used herein to mean “serving as an example, instance, or illustration.” Any embodiment described herein as “exemplary” is not necessarily to be construed as preferred or advantageous over other embodiments. In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or apparatuses. The following detailed description is therefore not to be taken in a limiting sense, and the scope of the present disclosure is defined by the appended claims and their equivalents.

### DETAILED DESCRIPTION OF THE INVENTION

Herein described are embodiments of a catalytic, sulfur-free chain transfer agent (CTA) that can be added in parts per million (ppm) quantities to monomer feedstocks to create crosslinked photopolymers like those prepared using traditional, sulfur-based chain transfer agents, but at 1,000 to 10,000 times lower CTA loadings. This catalyst may be incorporated into industrially relevant formulations and cured using standard practices with no special precautions or instrumentation. The resultant materials were found to have narrowed and reduced the glass transition temperatures, lower rubbery moduli, and other desirable mechanical properties. Described herein is a new class of CTA based on a transition metal, and the addition of small quantities of exogenous ligands were found to drastically alter catalyst performance, which may lead to further improvements in catalyst efficiency. This technology has potential applications in 3D printing, dentistry, protective coatings, adhesives, and liquid crystals.

The catalyst CTAs described herein may supplant sulfur-based chain transfer agents currently utilized in the formulation and processing of industrially relevant photopolymers. As discussed above, sulfur-based CTAs are required to be utilized in high loadings (up to 30 wt % of the total formulation) and, although they effectively reduce crosslinking density, because they account for a significant portion of the formulation can also negatively impact mechanical or material performance. For example, in crosslinked liquid crystals, large quantities of sulfur-based CTAs can dilute mesogen concentration, disrupt alignment, and create materials with paltry optical and mechanical properties. Further, sulfur-based CTAs generally impart color in the produced component, are inherently malodorous, and do not form shelf-stable formulations. Instead, only very small quantities (parts per billion (ppb) to ppm) quantities of the catalyst CTAs described herein is needed to be added to standard photopolymer formulations to obtain similar crosslinking densities and desired properties as sulfur-based CTAs while having no detectable smell and improving the stability and storability of the resulting photopolymeric resins. As a result, the catalyst CTAs described herein enable the formation of stronger, tougher, and more uniform materials, thus providing greater flexibility and scope of possible formulations of photopolymeric materials.

Cobalt(II)-porphyrin complexes have been used as chain transfer agents (CTA) to form low molecular weight terminated-PMMA (t-PMMA) through thermally initiated free radical polymerization of MMA. The t-PMMA polymers formed using the cobalt (Co)-based CTAs are short linear polymers terminated with alkene groups with low molecular weights (hundreds of Daltons (Da) instead of thousands of Daltons). The mechanism for forming these polymers is known as catalytic chain transfer (CCT) polymerization.

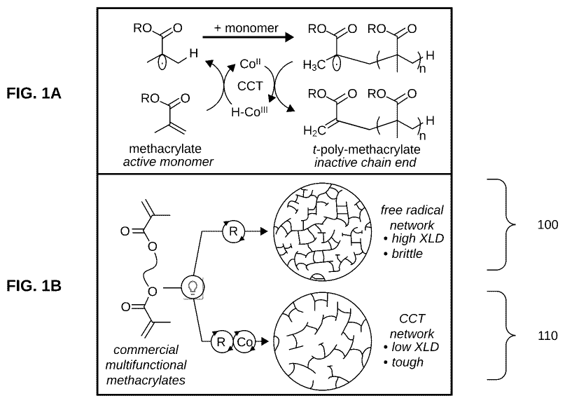

FIG. 1A illustrates a commonly accepted thermally activated CCT mechanism for the use of Co-based CTAs to form t-PMMA polymers. This method results in lower molecular weight linear t-PMMA polymers with alkene terminated ends.

FIG. 1B illustrates two pathways for the formation of photopolymers. The upper pathway, 100, involves the use of light to activate a photoinitiator to generate free radicals. The free radicals generate a polymer that has a high crosslinking density and brittle material properties.

The bottom pathway, 110, involves the use of light to activate a photoinitiator to generate free radicals in the presence of a Co-based catalyst. The Co-based catalyst can be used in small quantities (ppb to ppm levels) to modulate the network topology of the growing photopolymer. The Co-based catalyst is acting as a chain transfer agent (CTA) as discussed earlier. The resulting polymer has a lower crosslink density and has improved material properties such as toughness, etc.

Herein described are Co-based catalyst CTAs suitable for use with photopolymeric resins. These photopolymers have applications in the fields of additive manufacturing (3D printing), dentistry, adhesives, photonics, liquid crystal displays and actuators, protective coatings, among others. Direct evidence of catalytic chain transfer using a macrocyclic cobalt(II) complex has been obtained under relevant photopolymerization conditions, as described in detail below. Cobalt(II)-based catalysts were found to have chain transfer constants up to 1,000 times higher than the highest performing known CTA. Mechanical characterization of various commercially relevant formulations (such as those used in 3D printing resins and dentistry) were photopolymerized in the presence of this catalyst and were found to have correspondingly lower glass transition temperatures (e.g., 100 ppm of the macrocyclic cobalt catalyst reduced glass transition temperature T_{g} by ~20 C) and rubbery moduli (E′). These mechanical characteristics (T_{g} and E′) were found to be tunable by changing the concentration of the catalytic CTA in the resin.

The CTAs described here are catalytic and are not consumed like traditional CTAs during photopolymerization. Additionally, a large library of sigma-donating ligands can be evaluated which can increase or tune catalyst efficiency for a given photopolymer formulation. Some ligands that may be useful for certain application are nitrogen, oxygen or sulfur containing heterocycles (e.g., substituted pyridines), organophosphorus containing molecules (e.g., triarylphosphines), halides (e.g., tetrabutylammonium halide salts), nitrogen containing molecules (e.g., trialkylamines), oxygen containing molecules (e.g., ketones), and similar. In embodiments, size exclusion chromatography analysis of linear polymers formed by the addition of ppm quantities of a macrocyclic cobalt(II) complex to a digestible dimethacrylate confirm that cobalt(II) complexes may act as potent, catalytic chain transfer agents in photopolymeric materials.

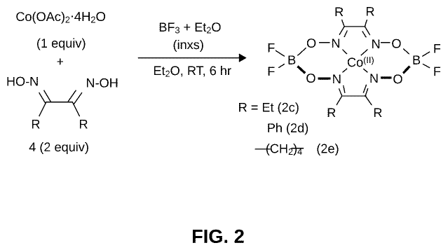

FIG. 2 illustrates the synthesis of families of Co-based catalysts. A wide variety of Co-based catalysts may be screened. For example, the Co-based catalyst shown in FIG. 2 where R is a methyl group may exhibit poor solubility in methacrylate monomer resins, while having a high activity. As illustrated in FIG. 2, cobalt(II) acetate tetrahydrate is reacted with two equivalents of a glyoxime in the presence of an excess of boron trifluoride diethyl etherate at room temperature. Conveniently, the catalysts prepared from this method precipitate and can be isolated by filtration. Large families of Co-based catalysts can be synthesized by altering the R group on the glyoxime as indicated in FIG. 2. This process forms a large family of compounds known as cobaloximes.

While FIG. 2 lists three potential R groups, this number is not meant to be limiting and it may be noted a broad range of potential R groups that may be evaluated. Properties such as solubility, stability, and catalytic activity of each Co-based catalyst may then be evaluated in the formation of photopolymers. In some embodiments, the R groups on the glyoxime are the same as those resulting in Co-based catalysts wherein all four R groups are the identical. In some embodiments, the R groups on the glyoxime may be different from each other, thus resulting in Co-based catalysts wherein all four R groups are not the same.

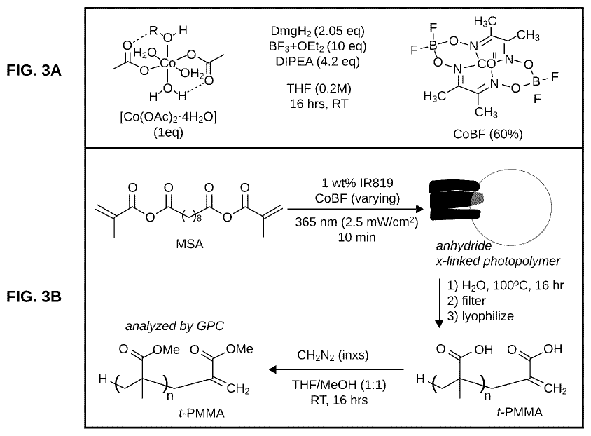

FIG. 3A illustrates exemplary Co-based catalyst synthesis for a specific compound. As discussed with respect to FIG. 2, cobalt(II) acetate tetrahydrate is reacted with dimethylglyoxime (DmgH₂), boron trifluoride etherate (BF₃ OEt₂), and N,N-Diisopropyethylamine (DIPEA). In this example, the four R groups are methyl groups and forms bis[(difluoroboryl)dimethylglyoximato]cobalt(II) abbreviated as CoBF. CoBF may be synthesized, for instance, with an acceptable yield of 60%.

FIG. 3B illustrates a method for using the Co-based catalyst (e.g., CoBF) to form and analyze the photopolymer. In this example, the monomer is methacrylated sebacic acid (MSA). Commercially available BAPO (bis(2,4,6-trimethylbenzoyl)-phenylphosphineoxide) is used as the photoinitiator to generate the free radicals active in the polymerization. The resulting polymer may then be degraded with water and lyophilized to yield a terminated-poly(methacrylic acid) (t-PMAA). The t-PMAA may be converted to t-PMMA and analyzed by size exclusion chromatography (SEC). The concentration of the CoBF can be varied during the photopolymerization step to form photopolymers with varying mechanical properties.

In some embodiments, a method of using a Co-based catalyst to synthesize a photopolymer is provided. The method comprises providing a cobaloxime catalyst at concentrations less than 10,000 ppm, providing a photoinitiator, providing one or more methacrylate monomers, and subjecting the mixture to a light source whose wavelength and intensity are tailored to create free radicals by dissociation of the photoinitiator.

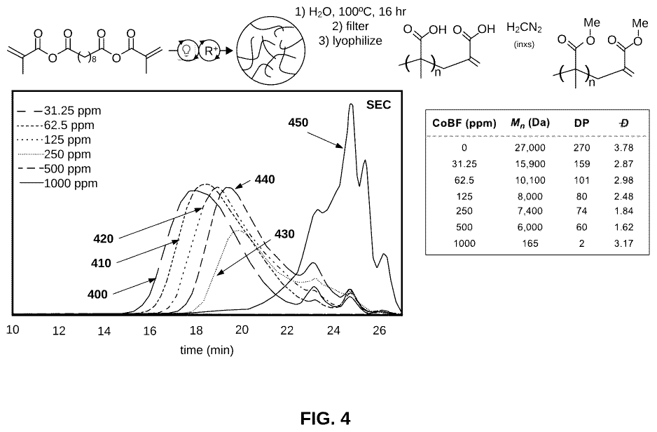

FIG. 4 presents analytical data of photopolymers prepared using the methods discussed with respect to FIGS. 3A and 3B. The concentration of CoBF was varied from 0 ppm to 1000 ppm (trace 400 is 31.25 ppm, trace 410 is 62.5 ppm, trace 420 is 125 ppm, trace 430 is 250 ppm, trace 440 is 500 ppm, trace 450 is 1000 ppm). In the absence of CoBF (0 ppm—no trace shown), the resulting photopolymer had an average molecular weight (Mₙ) of 27,000 Da, a degree of polymerization (DP) of 270, and a dispersity (Ð) of 3.78 as shown in the table. As the concentration of CoBF is increased from 31.25 ppm to 500 ppm, all three metrics decrease in a controllable manner. The sample with 1000 ppm CoBF, 450, did not gel and simply formed low molecular weight oligomers, as indicated in FIG. 4. These data confirm that Co-based complexes may catalytically reduce the kinetic chain length and the XLD of photopolymers derived from methacrylates.

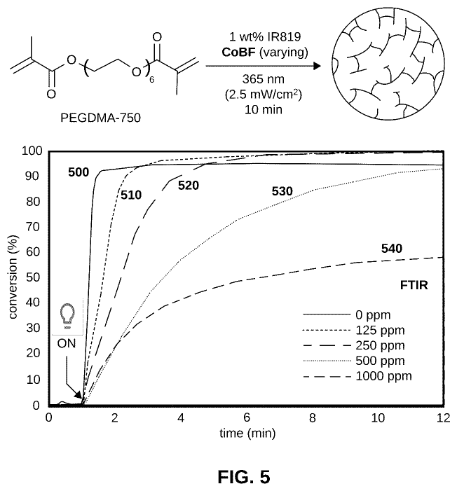

FIG. 5 presents analytical data of additional photopolymers prepared using the methods discussed with respect to FIGS. 3A and 3B. These photopolymers were synthesized using poly(ethylene) glycol dimethacrylate (PEGDMA) as the methacrylate monomer. The concentration of CoBF was again varied from 0 ppm to 1000 ppm (trace 500 is 0 ppm, trace 510 is 125 ppm, trace 520 is 250 ppm, trace 530 is 500 ppm, trace 540 is 1000 ppm). FTIR is used to follow the conversions of the double bonds during the polymerization as a function of time. These data give an indication of the gelation of the network. Trace 500 (0 ppm CoBF) presents the double bond conversion efficiency and kinetics in the absence of a Co-based catalyst. As the concentration of the Co-based catalyst is increased from 125 ppm, (trace 510), to 500 ppm, (trace 530), there is a delay in the gelation of the photopolymer. This delay is similar to that noted for non-catalytic sulfur-based CTAs, however without the drawbacks of using sulfur-based CTAs. Similar to the data presented in FIG. 4, relatively high concentrations (1000 ppm) of the Co-based catalyst exhibit long delays in the gelation and a very low conversion efficiency of the double bonds. Thus, the data in FIG. 5 indicate that Co-based CTAs are about one hundred times more active than sulfur-based CTAs.

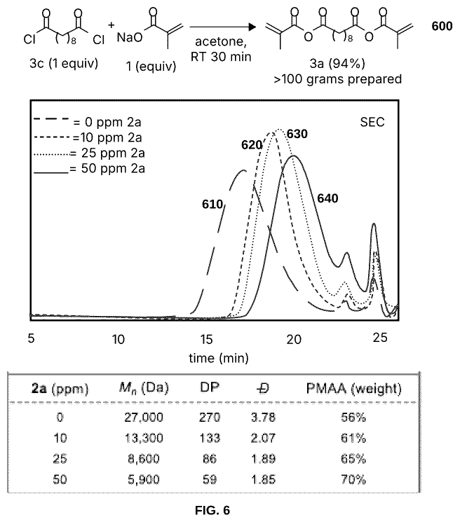

FIG. 6 presents analytical data of further photopolymers prepared using the methods discussed with respect to FIGS. 3A and 3B. These photopolymers were synthesized using methacrylated sebacic acid (MSA), 600. Initial results indicate that photopolymers synthesized using MSA would not gel at Co-based catalyst concentrations above about 500 ppm. The data presented in FIG. 6 indicate the influence of very low concentrations (0 ppm to 50 ppm) of the Co-based catalyst on the material properties of the resulting photopolymers (trace 610 is 0 ppm, trace 620 is 10 ppm, trace 630 is 25 ppm, trace 640 is 50 ppm). In the absence of CoBF (0 ppm), the resulting photopolymer had an average Mₙ of 27,000 Da, a DP value of 270, and a dispersity of 3.78. As the concentration of CoBF is increased from 10 ppm to 50 ppm, all three metrics decrease in a predictable manner. These data also indicate that the efficiency of the polymerization, as indicated by the PMAA weight increases at higher Co-based catalyst concentrations.

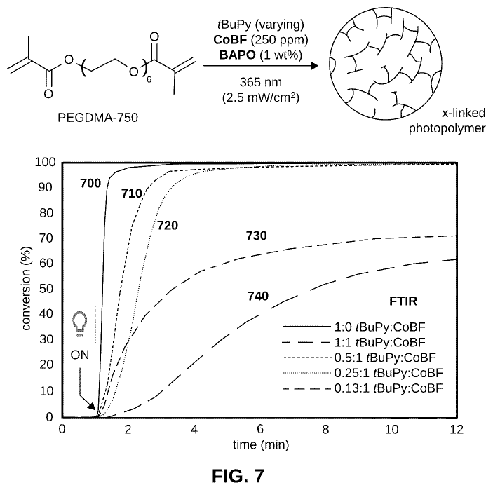

The Co-based catalysts discussed above have loosely coordinated axial ligands that may be readily displaced by more strongly sigma-donating ligands. The identity of the ligands also impacts the activity of these catalysts. FIG. 7 presents analytical data of photopolymers prepared using the methods discussed with respect to FIGS. 3A and 3B. Photopolymers were synthesized using PEGDMA in the presence of 250 ppm of CoBF, as discussed previously. These experiments utilized phenylbis(2,4,6-trimethylbenzoyl)phosphine oxide (BAPO) as the photoinitiator. 4-tert-butylpyridine (tBuPy) was added in varying amounts as a sigma-donating ligand. FIG. 7 presents Fourier Transform Infrared (FTIR) spectroscopy data following the conversion efficiency and kinetics of the double bond conversion as the ratio between the (tBuPy) ligand and CoBF is changed (trace 700 is a 1:0 ratio, trace 710 is a 0.5:1 ratio, trace 720 is a 0.25:1 ratio, trace 730 is a 0.13:1 ratio, trace 740 is a 1:1 ratio). Trace 700 indicates the polymerization in the absence of CoBF. Trace 740 indicates the polymerization where the ratio between the (tBuPy) and CoBF is 1:1. This trace indicates that both gelation and double bond conversion are suppressed at this ratio. Ratios between 0.5:1 and 0.25:1 (traces 710 and 720) indicate rapid gelation and high conversion efficiency. Further reduction of the ratio to 0.13:1 (trace 730) again suppressed gelation and indicated poor conversion. Therefore, the identity and concentration of sigma-donating ligands included during the polymerization may be used as additional parameters to tailor the use of Co-based catalysts in the synthesis of photopolymers.

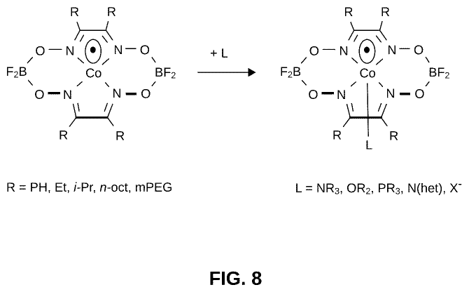

FIG. 8 illustrates opportunities to tailor the activity and performance of the Co-based catalysts through the selection of the R groups and ligands. As discussed previously, properties such as solubility, stability, and activity of the Co-based catalysts can be controlled by the proper selection of the R groups during their synthesis. A few R groups are listed in FIG. 8, including phenyl (Ph), ethyl (Et), isopropyl (i-Pr), n-octane (n-oct), and poly(ethylene glycol) methyl ether (mPEG). It is noted that this list is not intended to be exhaustive and that other R groups may be contemplated and are considered a part of the present disclosure. As discussed previously, in some embodiments, all the R groups may be the same. In some embodiments, some of the R groups may be different from each other.

FIG. 8 also indicates the interaction of various ligands with the Co-based catalyst as discussed with respect to FIG. 7. A few ligands are listed in FIG. 8, including amine (NR₃), ether (OR₂), thioether (SR₂), keto (O═CR₂), phosphine (PR₃), phosphine oxide (O═PR₃), phosphite (P(OR)₃, N-heterocyclic (N(het)), and halide (X⁻), among others. It is again noted that this list is not intended to be exhaustive and that other ligands may be contemplated and are considered to be a part of the present disclosure. In some embodiments, there may be more than one type of ligand species present during the photopolymerization step.

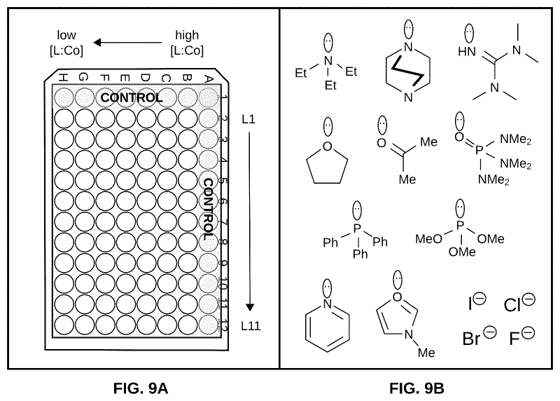

FIG. 9 illustrates a scheme for the high throughput synthesis and analysis of photopolymers formed using Co-based catalysts. As discussed previously, a thorough investigation of the photopolymerization parameter space is expensive in terms of time, materials, analytical equipment, and manpower. High throughput well plates can be used for initial screening experiments to identify concentration regions and sub-species identity before expending time and material on the synthesis of larger batches for bulk analysis.

As shown in FIG. 9, a 96 well plate may be used to implement an experiment where the identity and concentration of various ligands may be tested. In the illustrated example, within each well, the concentrations of the MMA monomer, photoinitiator, and Co-based catalyst may be held constant, while eleven different ligands may be evaluated in this scheme. For example, column A may serve as a control, with the highest loading of each ligand type and no Co-based catalyst. Thus, the wells of column A should result in the typical photopolymerization without the use of the catalysts discussed herein. Row 1, for example, may be a control that has no ligands present, but increasingly lower concentrations of the Co-based catalyst. Cell A1 may include no Co-based catalyst nor ligand and may serve as a negative control. The cells may be filled using typical chemical dispensing techniques. The entire plate can then be processed to form and analyze the resulting photopolymers. For instance, the degree of crosslinking may be inferred by including luminophore additives that change the intensity of their emission as a function of the crosslinking of the photopolymer. Such a scheme as shown in FIG. 9 allows rapid screening of the Co-based catalyst-ligand parameter space without having to generate bulk samples for each possible combination.

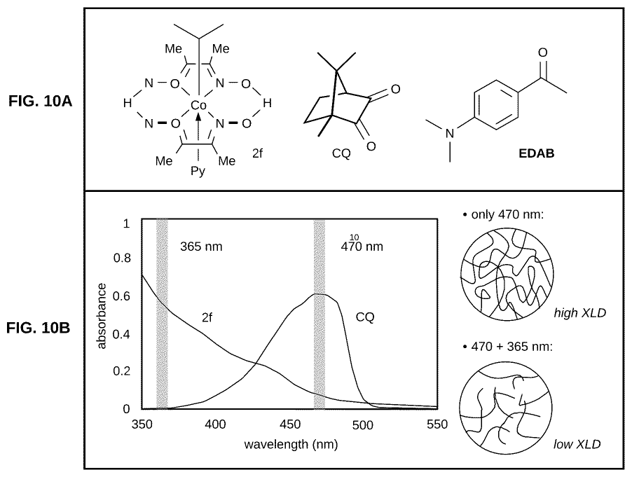

The Co-based catalysts discussed above may be based on Co(II) complexes that are active during the photopolymerization process. Similar Co(III) complexes may not be active and not exhibit catalytic function. FIG. 10 illustrates a process whereby inactive Co(III) complexes can be activated using light to generate active Co(II)-based catalysts in-situ.

As shown in FIG. 10, an inactive Co(III) catalyst may be used in the photopolymerization process as discussed previously. In this scheme, a photoinitiation system active in the visible light region is used. As an example, camphorquinone (CQ) and tertiary amine (ethyl 4-(dimethylamino)benzoate) (EDAB) may be used as the photoinitiator to generate the free radicals. This photoinitiation system works well at applied wavelengths of about 470 nm. The photolysis of cobalt-carbon bonds in cobaloximes has been well studied at wavelengths below 420 nm. When this system is exposed to light at a wavelength of about 470 nm, the Co(III)-based catalyst is inactive and the process results in a highly crosslinked photopolymer. When this system is exposed to light at dual wavelengths of about 470 nm and about 365 nm, the Co(III)-based catalyst may be activated to form an active Co(II)-based catalyst and the process results in a photopolymer with reduced crosslink density and different material properties from the photopolymer formed using only light of 470 nm wavelength.

This dual-wavelength scheme may be used to generate a photopolymer with spatially different material properties from the same input material by simply changing the wavelength(s) applied during the photopolymerization process. As an example, a photopolymer product piece may be manufactured wherein portions of the product piece include a highly crosslinked, brittle polymer (e.g., exposed to 470 nm wavelength light only) and other portions of the product piece are formed as a lower crosslinked, tougher polymer (exposed to, for example, 365 nm and 470 nm wavelength light during photopolymerization). This method may be used to generate active catalyst with spatial control. Alternatively, these species may also be generated in situ throughout the bulk of the material by reduction of a macrocyclic cobalt(III) complex by photolysis or by an addition-fragmentation mechanism (such as S_{H}2 mechanism) with an external source of free radicals.

The cobalt-based catalytic CTAs may be used, for example, to reduce volumetric shrinkage and shrinkage stress in crosslinked photopolymers primarily utilized in additive manufacturing (i.e., 3D printing) and dentistry (such as in bis-GMA/TEGDMA resins). Further, the CTAs described above may be used to increase the efficiency and intensity of actuation in liquid crystal actuators and liquid crystal displays formed using photopolymeric methods. Further, the catalytic CTAs described above may be modified to tunably alter the mechanical properties of a commercial resin catalytically without changing the monomer formulation. Such material tunability may have applications in a variety of fields, such as adhesives, protective coatings (such as for optical fiber manufacturing), additive manufacturing resins, and bulk photopolymers, among other uses.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The terms and expressions employed herein are used as terms and expressions of description and not of limitation, and there is no intention, in the use of such terms and expressions, of excluding any equivalents of the features shown and described or portions thereof. Each of the various elements disclosed herein may be achieved in a variety of manners. This disclosure should be understood to encompass each such variation, be it a variation of an embodiment of any apparatus embodiment, a method or process embodiment, or even merely a variation of any element of these. Particularly, it should be understood that the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled.

As but one example, it should be understood that all action may be expressed as a means for taking that action or as an element which causes that action. Similarly, each physical element disclosed should be understood to encompass a disclosure of the action which that physical element facilitates. Such changes and alternative terms are to be understood to be explicitly included in the description.

1. A method for producing photopolymers, comprising:
providing an active monomer feedstock;
adding a catalytic chain transfer agent (CTA) to the active monomer feedstock to form a mixture with a concentration of the catalytic CTA less than 30% of the mixture; and
applying energy from a light source to form a photopolymer structure,
wherein the catalytic CTA is a Cobalt(II)-based catalyst.

2. The method of claim 1, wherein the concentration of the catalytic CTA is on an order of ten parts per million (ppm) of the mixture.

3. The method of claim 1, wherein the concentration of the catalytic CTA is on an order of ten part per billion (ppb) of the mixture.

4. The method of claim 1, wherein the catalytic CTA is sulfur-free.

5. The method of claim 4, wherein the catalytic CTA exhibits a chain transfer constant at least 10 times higher than that of a sulfur-based catalytic CTA.

6. The method of claim 4, wherein the catalytic CTA exhibits a chain transfer constant at least 100 times higher than that of a sulfur-based catalytic CTA.

7. The method of claim 1, further comprising adding a sigma-donating ligand to the catalytic CTA such that material properties of the photopolymer structure therewith are modified.

8. The method of claim 7, wherein the sigma-donating ligand includes at least one of nitrogen-containing heterocycles, oxygen-containing heterocycles, sulfur-containing heterocycles, organophosphorus containing molecules, halide salts, nitrogen containing molecules, and oxygen containing molecules.

9. The method of claim 7, wherein the material properties include at least one of mechanical properties, optical properties, crosslinking density, and shelf stability.

10. The method of claim 1, wherein the active monomer feedstock includes a methacrylate monomer.

11. The method of claim 1, wherein the active monomer feedstock includes a petroleum-derived (meth)acrylate.

12. The method of claim 1, wherein the active monomer feedstock includes a poly(methyl methacrylate) (PMMA).

13. The method of claim 12, wherein a molecular weight of the PMMA in the photopolymer structure is reduced from an order of thousands of Dalton (Da) in an unmodified photopolymer structure without the catalytic CTA to an order of hundreds of Da in the photopolymer including the catalytic CTA.

14. The method of claim 1, wherein the catalytic CTA includes a Co(II)-complex.

15. The method of claim 14, wherein the catalytic CTA includes a Co(III)-hydride (Co(III)-H).
